(19) United States
(12) Patent Application Publication
(10) Pub. No.: US 2009/0248355 A1
(43) Pub. Date: Oct. 1, 2009

(54) METHOD AND DEVICE FOR MEASURING AT LEAST ONE HOLE IN AT LEAST ONE SURFACE OF A COMPONENT

(76) Inventor: Josef Kriegmair, Langenpreising (DE)

Correspondence Address: GREER, BURNS & CRAIN, 300 S WACKER DR, 25TH FLOOR, CHICAGO, IL, 60606, US

(21) Appl. No.: 12/408,210

(22) Filed: Mar. 20, 2009

(30) Foreign Application Priority Data
Mar. 28, 2008 (DE) 10 2008 016 026.1

(51) Int. Cl. G01B 11/00; G06F 15/00

(52) U.S. Cl. 702/155

(57) ABSTRACT

A method for measuring at least one hole in at least one first surface of a component, in particular for turbomachines, in which at least the following steps are executed: a) provision, using a data processing system, of a target geometry of the component at least for the area of the hole, the target geometry characterizing at least one first target surface of the component in the area of the hole, b) determination, using a measurement system, of an actual geometry of the component at least for the area of the hole, the actual geometry characterizing at least one first actual surface of the component in the area of the hole, and c) determination, using the data processing system, of an actual geometry of the hole on the basis of a deviation between the target geometry and the actual geometry of the component.

### BACKGROUND

The present invention relates to a method and to a device for measuring at least one hole in at least one first surface of a component, in particular of turbomachines.

From WO 2007/028355 A1, a method and a device are known by which at least one hole can be made in a component. Here, standardly a large number of holes, which may for example be realized as cooling air holes, are made in the component at a small distance from each other, having different geometrical characteristics and being made at different angles in the component. In addition, at least some of the holes are often situated in close proximity to wall geometries of the component.

However, up to now a process-stable manufacturing has been complicated by complex target geometries of the component, for example in what are known as airfoils, and unavoidable manufacturing tolerances, both in the actual geometry of the component and in the respective hole. Here, high demands are made in particular on cooling air holes, in particular shaped holes or turbulent holes, with regard to precision of position and characteristics, in order to ensure the required cooling performance for the component. Otherwise, for example due to an inadequately fashioned funnel shape of the hole, overheating of the component may result, possibly resulting in limitations on the functioning of the turbomachine. Therefore, a precise measuring of the hole is of great interest during manufacture, repair, and maintenance. Up to now, the measurement of the holes has been accomplished using tedious and expensive manual methods (pinning) or via an optical determination of the position of the puncture opening of the hole in the surface of the component. However, this does not provide any information concerning the orientation or the concrete macro- or microgeometry of the hole, so that an evaluation of the quality of the hole, and thus of the component, is not possible.

Therefore, the object of the present invention is to create a method and a device for measuring at least one hole in at least one first surface of a component that enable an improved and accelerated conclusion to be drawn concerning the quality of the hole.

### SUMMARY

A method according to the present invention by means of which an improved and accelerated assessment of the quality of at least one hole in a component is made possible comprises at least the steps: a) provision of a target geometry of the component at least for the area of the hole, using a data processing system, the target geometry characterizing at least one first target surface of the component in the area of the hole, b) determination of an actual geometry of the component at least for the area of the hole using a measurement system, the actual geometry characterizing at least one first actual surface of the component in the area of the hole, and c) determination of an actual geometry of the hole of the basis of a deviation between the target geometry and the actual geometry of the component, using the data processing system. Due to the fact that it can be automated easily, the method according to the present invention enables significant savings in time and costs in comparison with the previous manual measurements, and thus permits stable, unmanned operation. In addition, with the aid of the method precise and reliable information is obtained particularly quickly concerning the deviation between the actual geometry and the target geometry of the hole, because tolerances that may exist in the actual geometry of the component or of the hole, caused for example by shifting, rotation, tilting, or the like, are taken into account in an optimal manner. In this way, with the aid of the method according to the present invention a high degree of process stability and process speed are ensured during manufacture, repair, or maintenance of the component. In addition, the method creates new possibilities of process controlling, so that for example a quality controlling can be carried out immediately after the production of the hole, or the actual geometry of the hole can be used as a starting point for subsequent holes, dimensions, angular settings, or the like, without additional manual interventions.

In an advantageous construction of the present invention, it is provided that the hole extends from the first surface to a second surface of the component. In other words, the hole is made continuous. Here it can be provided that the actual geometry of the component is determined separately or successively for each actual surface.

Additional advantages result in that the target geometry of the component characterizes at least the second target surface, and/or the actual geometry of the component characterizes at least the second actual surface of the component in the area of the hole. This enables a simple measuring of the continuously fashioned hole in one pass through the method. With the aid of the method according to the present invention, it is also possible quickly and reliably to take into account and to measure tolerances that may exist between the two surfaces, for example an offset from one another.

In a further construction, it has turned out to be advantageous if the component and the measurement system are situated relative to one another before determining the actual geometry in step b), in a manner dependent on the construction of the measurement system. In other words, before the determination of the actual geometry the component and the measurement system are moved relative to one another into a position that is suitable for the measurement system. Here, the position depends on the particular construction of the measurement system. This ensures the greatest possible precision of the subsequently determined actual geometry.

In another advantageous construction of the present invention, it is provided that the actual geometry of the component is determined in step b) using a tactile and/or optical and/or radiographic and/or ultrasonic measurement device of the measurement system. In this way, the respective material and the respective geometry of the component can be optimally taken into account by a corresponding construction of the measurement system. Further advantages result in that the target geometry of the component and/or the actual geometry of the component characterize a macrogeometry, in particular a dimension and/or a shape, of the hole, and/or a microgeometry characterizes in particular a roughness and/or a crack formation of the hole. With the aid of the macrogeometry, information can be gained particularly easily concerning what is called the drawing specification of the component. The knowledge of the microgeometry alternatively or in addition enables assessments of the quality of the manufacturing process, thus enabling a regulated process controlling.

In another advantageous construction of the present invention, it is provided that the target geometry of the component and/or the actual geometry of the component characterizes a macrogeometry, in particular a dimension and/or a shape, of the hole, and/or a microgeometry, in particular a roughness and/or a crack formation, of the hole.

Furthermore, it has turned out to be advantageous for the determination of the actual geometry of the component in step b) to be carried out in a predetermined search area of the component. Due to the positional tolerance of the hole, which is relatively large relative to the hole cross-section, with the aid of the predetermined search area it is ensured that the position of the hole can be determined quickly and reliably. If the hole cannot be located within the search area, the component has insufficient quality. In this case, the process may then proceed according to a defined set of regulations.

Further advantages result in that the actual geometry of the component is determined in step b) on the basis of box dimensions and at least one shape of a surface of the hole, and/or on the basis of length dimensions and angular dimensions. A determination on the basis of length dimensions and angular dimensions—including tolerances in each case if warranted—represents a possibility for rapid, simple measurement. Alternatively, or in addition, a measurement using box dimensions (nominal dimensions) can also be carried out, in which shapes of a surface are determined for the overall actual geometry in the area of the hole, or for a part of the actual geometry in the area of the hole.

In another advantageous construction of the present invention, it is provided that in step b) component bases, in particular main planes of the component, and/or a target axis of the hole are determined. Because the position of the hole is a function of the actual geometry and/or the orientation of the component, by determining the component bases (for example, the three main planes or the outer geometry of the component) the determination of the actual geometry of the component is correspondingly improved at least in the area of the hole. With the aid of this information, the target position of the hole in the component can be determined. The determination of the target hole axis makes easier a later evaluation of the position and orientation of the actual hole axis relative to the component.

In a further construction, a further improvement of the determination of the actual geometry of the component is achieved in that the component bases are determined on the basis of base points of the component and/or on the basis of points of support of the component on a measuring device, and/or on the basis of a surface acquisition of the component, and/or on the basis of a component acquisition. The component bases, or the main planes, can for example be determined by iterative measurement of base points (6-point nest) and/or via points of support of the component on a measuring device. Alternatively, or in addition, particularly precise information can be gained about the target position of the hole, taking into account the actual geometry of the component, via a preferably optical surface acquisition, or via a partial or complete component acquisition (for example with the aid of a computer tomography method) with subsequent determination of the base points and base planes of the component.

Here, in a further construction it has turned out to be advantageous if in step b) a target puncture point of the hole is determined in the actual surface on the basis of the target axis of the hole and the actual geometry of the component. The target puncture point of the hole can preferably be used as a basis for the subsequent determination of the actual geometry of the hole. The determination of the target puncture point can for example be accomplished by formal closing of the hole opening in the actual outer geometry, or by partial acquisition of the actual surface of the component (e.g. with the aid of partial surfaces, points, lines) in the area of the hole, and subsequent calculation of the point of intersection between the target hole axis and a radius of curvature determined therefrom. Alternatively, or in addition, a target radius of curvature in the area of the target puncture point may also be used, or an actual outer geometry of the component, acquired before the perforation of the component, may be used. Here, in order to simplify the determination it has turned out to be advantageous to carry out a transformation of the required parameters into a suitable, hole-specific base system.

Further advantages result from the determination in step c) of an actual axis of the hole and/or an actual puncture point of the hole in the actual surface. This enables particularly reliable information to be gained concerning various actual parameters of the hole, such as the hole angle and hole length, as well as rotation or displacement of the hole relative to the target position.

In another advantageous construction of the present invention, it is provided that the target hole axis is used to determine the actual hole axis, and/or the actual hole axis is determined on the basis of the target geometry of the component. In particular for cases in which there is a high degree of measurement uncertainty, this achieves a corresponding improvement in the determination. For example, the hole axis may be so short, or so strongly truncated, that it cannot be determined in a process-stable fashion.

In addition, it is advantageous if an area of the actual geometry of the component that, taking into account the target geometry of the component, lies outside a predetermined range of tolerance, is not taken into account in the determination of the actual geometry of the hole in step c). This is advantageous in particular if the hole is comparatively short or has a surface having a high degree of roughness compared to the hole cross-section. A particularly process-stable execution of the method is thus enabled, in that areas that deviate strongly from the target geometry and that do not meet a particular degree of quality, which is a function of, inter alia, the surface roughness and the hole tolerance, are not taken into account in the determination in step c).

In a further advantageous construction of the present invention, it is provided that in step c) a funnel parameter of the hole is determined, in particular a funnel angle and/or a funnel width and/or a funnel depth and/or a funnel edge and/or a funnel surface of transition to the surface of the component and/or a radius of curvature between the funnel transition surface and the surface of the component. Even in the case of holes having a complex geometry, this enables particularly precise information to be gained about the actual geometry of said holes.

Further advantages result in that, in a further step d), the actual geometry of the hole determined in step c) is evaluated and/or represented. This enables a particularly simple, rapid assessment of the quality of the hole or of the component. In this way, unnecessary post-processing and rejection costs can reliably be avoided, because it is ensured that only components that are within specifications are supplied to be used for their intended purpose.

Here, in a further construction it can be provided that in step d) a documentation is carried out and/or a representation is produced, in particular a color representation, characterizing a deviation of the actual geometry from the target geometry of the hole. The documentation can be accomplished for example on the basis of a written and/or electronic protocol. Alternatively, or in addition, a corresponding display screen representation may be produced in which colors corresponding to the deviation are preferably used. For example, deviations lying outside the range of tolerance may be given a first color, and those within the range of tolerance may be given a second color. Alternatively, for deviations within the range of tolerance, color gradients corresponding to the magnitude of the deviation may be used. The assignment of colors to the individual points of the geometry can be accomplished on the basis of predetermined fixed values, or in variable fashion on the basis of the respective maximum and minimum deviations.

In a further construction, an improvement in the quality assurance of the component is enabled in that the method is aborted when an actual geometry of the hole is evaluated as defective. This enables an immediate identification and subsequent improvement of the relevant hole, whereby the component can be manufactured with the required degree of quality quickly and reliably.

A further improvement in measurement precision is achieved in that the actual geometry, determined in step c), of the hole is spatially oriented before the evaluation in step d), in a manner dependent on the target geometry of the hole. Here, in particular an actual geometry of the hole that deviates strongly from the target geometry can advantageously be taken into account.

A particularly precise determination of the quality of the component is enabled in that a plurality of holes of the component are measured. It can of course also be provided here that all holes of the component are measured.

In a further advantageous construction of the present invention, it is provided that the component is a turbine blade of a turbomachine, in particular a thermal turbomachine, and/or the hole is a cooling air hole. In the context of the method according to the present invention, in this way a particularly high degree of quality and performance of the component can be ensured, and failure of the turbomachine, or excessive overheating of the component, can reliably be excluded.

A further aspect of the present invention relates to a device for measuring at least one hole in at least one first surface of the component, in particular for turbomachines, comprising according to the present invention a measurement system by means of which an actual geometry of the component is capable of being determined at least for the area of the hole, the actual geometry characterizing at least one first actual surface of the component in the area of the hole, and comprising a data processing system capable of being coupled to the measurement system, by means of which a target geometry of the component can be provided at least for the area of the hole, the target geometry characterizing at least one first target surface of the component in the area of the hole, and by means of which an actual geometry of the hole can be determined taking into account the target geometry and the actual geometry of the component. Thus, the device according to the present invention enables an improved and accelerated assessment of the quality of the at least one hole of the component. The preferred specific embodiments and developments presented in connection with the method according to the present invention, and the advantages thereof, hold correspondingly for the device according to the present invention.

Further advantages, features, and details of the present invention result from the following description of exemplary embodiments, and on the basis of the drawings, in which identical or functionally identical elements have been provided with identical reference characters.

### BRIEF DESCRIPTION OF THE DRAWINGS

FIG. 1 shows a schematic lateral sectional view of a target geometry of a first component having a plurality of holes;

FIG. 2 shows a schematic lateral sectional view of an actual geometry and of a target geometry of a second component having a hole;

FIG. 3 shows a schematic lateral sectional view of the actual geometry and target geometry of the second component, in which a target puncture point of a target axis of the hole is determined;

FIG. 4 shows a schematic lateral sectional view of the actual geometry and of the target geometry of the second component, in which an actual puncture point of an actual axis of the hole is determined;

FIG. 5 shows a schematic lateral sectional view of a third component;

FIG. 6 shows a schematic top view and a schematic side view of a hole in a fourth component;

FIG. 7 shows a schematic lateral sectional view and a schematic top view of a fifth component, in which the actual geometry is determined in the area of a plurality of holes on the basis of length measures and angular measures;

FIG. 8 shows a schematic lateral sectional view and a schematic top view of the fifth component, in which the actual geometry is determined in the area of a plurality of holes on the basis of box dimensions and surface shapes;

FIG. 9 is a schematic lateral sectional view of the hole in a further component, in which areas of the actual geometry of the component lying outside a range of tolerance are excluded from consideration;

FIG. 10 is a schematic lateral sectional view of the hole in a further component, in which various funnel dimensions are determined; and

FIG. 11 is a schematic top view and a schematic lateral sectional view of the hole in a further component, in which deviations of the actual geometry from the target geometry are taken into account.

### DETAILED DESCRIPTION

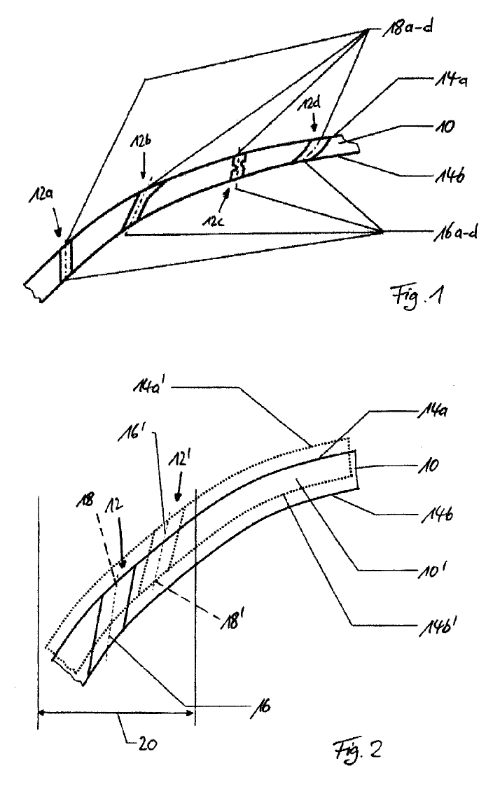

FIG. 1 shows sections of a schematic lateral sectional view of a target geometry of a first component 10 of a thermal turbomachine (e.g. an airfoil), having a plurality of holes 12a-d that are fashioned as cooling air holes. Component 10 has a first and a second surface 14a and 14b, which characterize its outer and inner geometry. The individual holes 12a-d, which are predominantly cylindrical and/or funnel-shaped, extend continuously from the first to the second surface 14a, 14b, and each have different target geometries with corresponding target hole axes 16a-d, via which corresponding target puncture points 18a-d of holes 12a-d in surfaces 14a, 14b can be determined. Hole axes 16 fundamentally characterize the respective hole direction during manufacture. In addition, holes 12a-d are situated with a small spatial distance from one another, and are partly situated close to wall geometries.

In practice, manufacturing tolerances on first and second surfaces 14a, 14b, and an offset of these two relative to one another, make process-stable manufacturing more difficult. In addition, unavoidable manufacturing tolerances of surfaces 14a, 14b cause displacement, rotation, and tilting of the actual component 10, which influences the position and properties of holes 12a-d. However, high demands are made on holes 12a-d, fashioned as air cooling holes, with regard to their properties, so that they can provide the specified cooling performance for component 10. If the cooling performance is too low, for example due to an inadequately formed funnel shape of the respective hole 12b, this can result in overheating of component 10, and, as a further consequence, failure of the turbomachine. This holds both for the initial manufacture of component 10 and for later maintenance, reconditioning, or repair. Therefore, a rapid, precise, and cost-efficient measurement of holes 12a-d is of great interest in order to enable monitoring of adherence to the drawing specifications characterized by the target geometry in process-stable fashion and with at least a large degree of automatability.

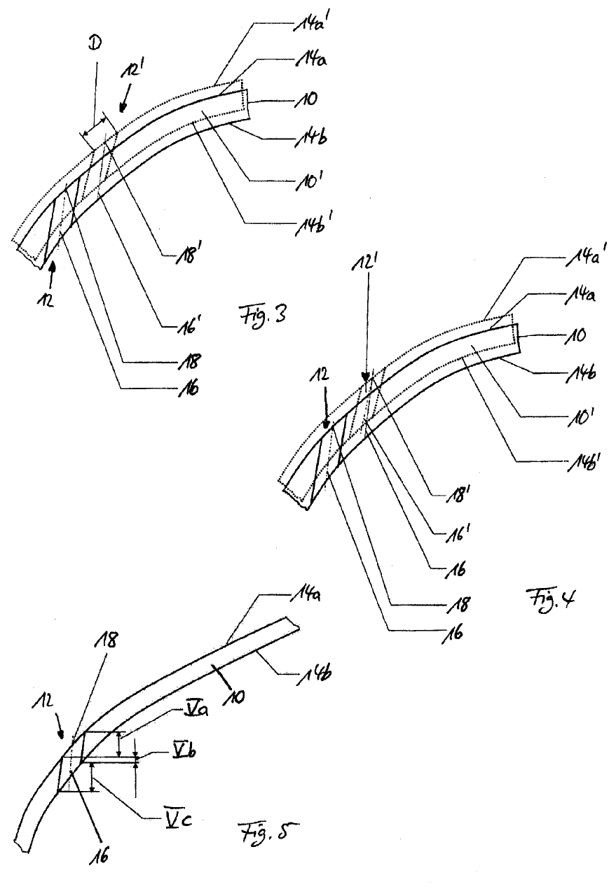

The method according to the present invention used for this purpose is now explained in more detail on the basis of the following drawings. FIG. 2 shows a schematic lateral sectional view of a target geometry, shown in solid lines, of a second component 10, having a hole 12 that includes a hole axis 16, and an actual geometry, shown in dotted lines, of second component 10′. In the following, the reference characters of all elements relating to the actual geometry are provided with an additional ′. The same holds correspondingly for parts of the description that relate specifically to the actual geometry. Both the actual geometry and the target geometry of component 10 are preferably present in the form of multidimensional CAD data, or are converted into this form after being determined, in order to enable simple processing by a data processing system. The measuring of hole 12′ requires the determination of the actual geometry of component 10′ in the area of hole 12′, with the aid of a tactile, optical, radiographic, or ultrasonic measurement device of a measurement system. Here, the actual position of hole 12 in each case depends on component bases of component 10′—for example three main planes, one of the surfaces 14a′, 14b′, or target hole axis 16. The main planes of component 10′ are determined either through iterative measurement of base points (e.g. 6-point nest). Alternatively, or in addition, the component bases can be determined on the basis of support points of component 10′ on a measurement device, or on the basis of an optical surface acquisition of component 10′, or on the basis of a component acquisition (for example with the aid of a computer tomograph) with subsequent determination of the base points and base planes. On the basis of this information, the target position of hole 12 can be determined.

Because hole 12′ standardly has a comparatively large positional tolerance in comparison to its diameter or cross-section D (see FIG. 3), the determination of its actual geometry is at first usefully carried out in a predetermined search area 20. This can be accomplished for example with the aid of an image processing or an evaluation of an actual surface 14a′ or 14b′, determined at least in search area 20, of component 10′. If hole 12′ cannot be found in search area 20, component 10′ does not have the required degree of quality and must correspondingly be improved. In this case, the measurement method can be aborted. Alternatively, a written or electronic documentation of the error is produced, and if warranted the process continues with the measurement of a further hole 12 or of a further component 10.

FIG. 3 shows a schematic lateral sectional view of the actual geometry and target geometry of second component 10. Through formal displacement of target hole axis 16, its actual puncture point 18′ in the actual geometry of component 10′ is determined. This can be accomplished for example through formal closing of gaps in actual surface 14a′ or 14b′, or through partial acquisition of actual surface 14a′ or 14b′ via partial surfaces, points, or lines in the area of hole 12. It is also conceivable to determine a point of intersection between hole axis 16 and a radius of curvature of surface 14a or 14b, derived taking into account the actual or target geometry, or to determine the actual puncture point 18′ on the basis of an actual geometry in this area, acquired before the perforation of component 10′. In the following, the determined actual puncture point 18′ is used as a basis for the further measuring of hole 12′. If a different base system, for example a base system of component 10, is used in the determination, a hole-specific transformation of the geometry data into this base system has proved advantageous.

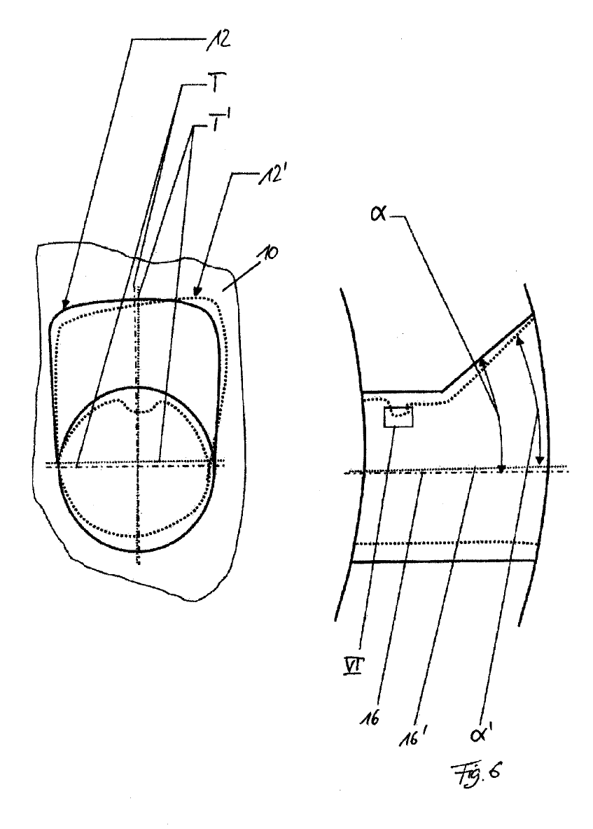

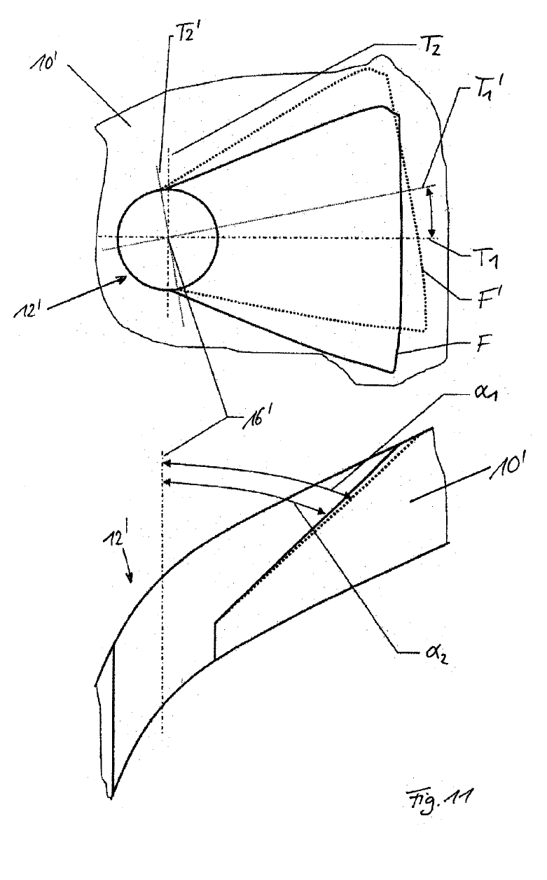

FIG. 4 shows a schematic lateral sectional view of second component 10, in which, differing from the previous exemplary embodiment, the actual puncture point 18′ is determined on the basis of the actual axis 16′ of hole 12′. Actual hole axis 16′ can be determined either on the basis of the determined actual geometry of component 10′ or by additional measurement in hole 12′. For comparison, the formally displaced target hole axis 16 is also shown in actual hole 12′. By means of a tactile, optical, radiographic, or ultrasonic measurement device of the measurement system, here the macrogeometry and microgeometry of hole 12 is determined for example in the form of individual measurement points, measurement sections, or by partial or complete acquisition of surfaces 14a′ or 14b′. Alternatively, actual geometry data that were already acquired previously, for example during the determination of the component bases, may advantageously be reused for this purpose. Here, macrogeometry is to be understood for example as a dimension or shape of hole 12′, and microgeometry is to be understood as for example a surface roughness or crack formation of hole 12′. As needed, component 10′ and the measurement system are situated relative to one another, in a manner dependent on the construction of the measurement system, before the determination of the macrogeometry and microgeometry, in such a way that the respective measurement device is brought into an optimal position relative to hole 12′. This improves the determination of the actual hole axis 16′, as well as the actual geometry of hole 12′. From the actual geometry, specific hole parameters can be determined as needed, such as hole diameter D, the hole length, a funnel length, a funnel width TB (see FIG. 10), a funnel depth TT (see FIG. 10), a funnel angle α (see FIG. 6), shape deviations, and direction-dependent or direction-independent positional tolerances (rotation, displacement). Here it may also be provided that the respective base system or material properties of component 10′ are additionally taken into account.

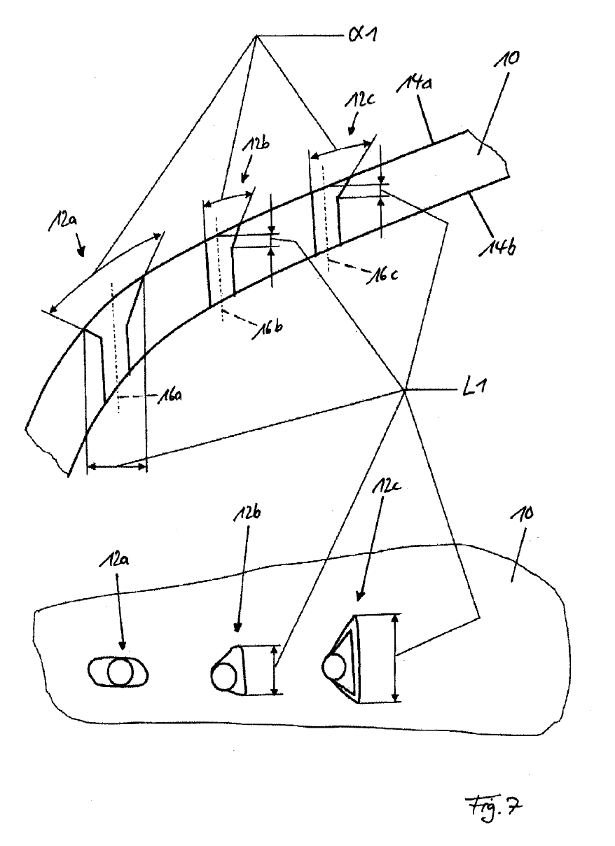

FIG. 5 shows a schematic lateral sectional view of a third component 10. Due to the angle of curvature of surfaces 14a, 14b, a process-stable determination of the actual hole axis 16′ is not possible, because of measurement areas Va-c, only measurement area Vb is available for this purpose. In this case, it has turned out to be advantageous to use target hole axis 16 as the actual hole axis 16′, taking into account the actual geometry of the component. In the case of highly truncated holes 12, it is also possible, given knowledge of the target geometry, to use target surface areas of hole 12 in order to enable provision of measurement data concerning a longer length area. Alternatively, it may be provided as needed to carry out an adaptation of the target geometry to the actual dimensions of hole 12. In this way as well, a stabilization of hole axis 16 is achieved for a given degree of measurement uncertainty. Here it must be kept in mind that the determination of actual puncture points 18′ is optional if no element requires actual puncture point 18′ as a basis, so that it is insignificant for the measurement process.

FIG. 6 shows a schematic top view, and a schematic side view, of a hole 12 of a fourth component 10, the target and actual geometries again being shown. Holes 12 may have in general a rough surface or a surface having cracks, such that the roughness or crack formation may be relatively large (as shown in detail VI) compared to the hole diameter D or to a main funnel axis T. In particular in the case of short hole axes 16, both result in strong changes of direction, resulting in corresponding displacements of actual puncture point 18. Of course, this has an effect on all elements that have hole axis 16 or puncture point 18 as a basis. These elements include for example, given at least partly funnel-shaped holes 12, the funnel angles a of main funnel axes T, funnel depths TT, funnel widths TB, rotations and tiltings of the funnel, or bases for subsequent holes. It is therefore advantageous for process-stable information not to take into account, at least during the determination of actual hole axis 16′, areas that deviate strongly from a target shape and that thus do not reach a degree of quality that is a function of, inter alia, the surface roughness and the hole tolerance.

The dimensional or measurement system used for the measuring, as well as the respective measurement construction, have a decisive influence on the quality of the measurement.

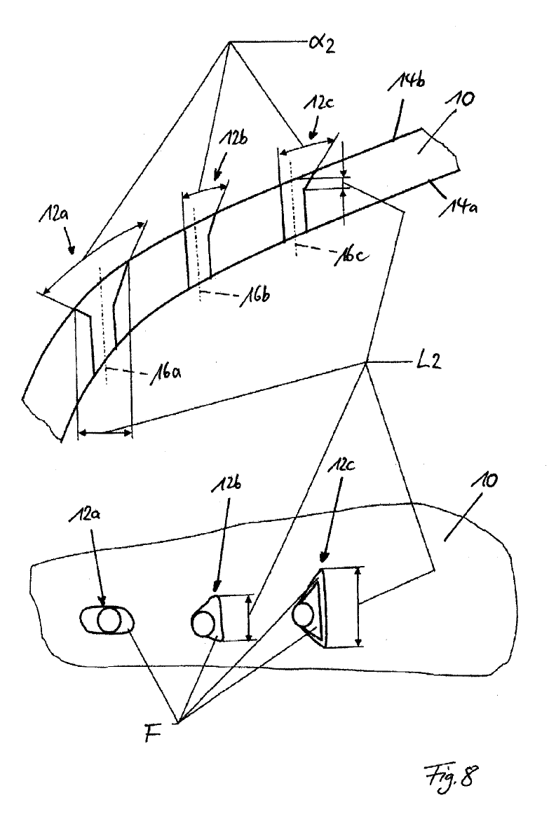

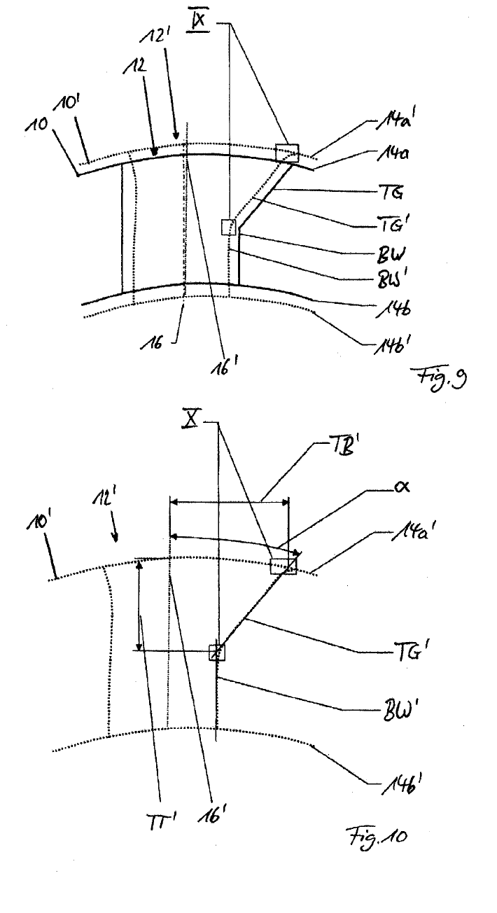

FIG. 7 shows a schematic lateral sectional view, as well as a schematic top view, of a fifth component 10 in which the actual geometry in the area of a plurality of holes 12a-c is determined as an example on the basis of length dimensions L1 and angular dimensions α1, with respective tolerances. An alternative variant is a measurement via boxed dimensions (nominal dimensions) and surface shapes for the determination of a partial or complete actual geometry of funnel-shaped holes 12. For this purpose, FIG. 8 shows a schematic lateral sectional view and a schematic top view of fifth component 10, in which the actual geometry in the area of holes 12a-c is determined on the basis of box lengths L2, box angles α2, and additional surface shapes F.

A measurement via box dimensions L2, α2 and surface shapes F offers various advantages, because the determination of angles that can be measured with the required degree of precision only with difficulty in the case of short limb lengths, or in the case of rotation or tilting of the holes 12a-c, is omitted. For the geometry measurement data of surface shapes F, on the basis of the target geometry of component 10 a comparison takes place in order to determine whether the surfaces are within the range of tolerance. The basis for the evaluation is for example the respective actual or target hole axis 16a-c, because this axis defines the position of funnel-shaped holes 12a-c. The transition areas from holes 12a-c to the respective surfaces 14a or 14b, and the transition areas from different wall areas of holes 12a-c, are taken into account during the evaluation for example as roundings, or by leaving the transition areas out of the determination. Here, the size of actual holes 12a-c has an influence on the respective transition area, and is correspondingly taken into account as needed during the determination. As an illustration of this, FIG. 9 shows a schematic lateral sectional view of hole 12 of a further component 10, areas designated IX of the actual geometry of component 10′, lying outside a particular tolerance range, being excluded from consideration. TG, or TG′, designates the target geometry or the actual geometry of a funnel-shaped area of hole 12, whereas BW or BW′ designates a cylindrical area of hole 12. The actual geometry of hole 12′, determined in this way, can subsequently be documented via corresponding protocols, and/or preferably can be shown on a display screen via a color representation, such that the color allocation particularly preferably corresponds to a deviation of the actual geometry from the target geometry of the hole, in order to enable a rapid assessment to be made of the quality of component 10.

If the orientation of the actual geometry of hole 12 deviates too far from the orientation defined in the target geometry, for example on the basis of a rotation of hole 12, including the funnel, about hole axis 16, or a tilting about a funnel main axis T, this deviation is taken into account through corresponding method steps in the determination of actual funnel angles α′. Here, the method steps can for example comprise a three-dimensional fitting into the target geometry, provided with tolerance ranges if warranted, an orientation via defined points or sections of component surfaces, a self-centering measurement, an orientation of the actual shape (actual footprint) of a funnel-shaped area of hole 12 projected into a plane that is normal to the actual hole axis 16′, or the like. For this purpose, FIG. 10 shows a schematic lateral sectional view of an actual geometry of a further component 10′, in which various funnel dimensions of hole 12′ are determined. In this example as well, the areas designated X of the actual geometry of component 10′ do not meet the prespecified tolerance criterion, and are therefore excluded from consideration. This holds in particular for the transition areas between the cylindrical and the funnel-shaped area BW′ or TG′ of hole 12′, as well as the transition from hole 12′ to surface 14a′. Here, the exclusion of the areas X reliably prevents distortion and falsification of various parameter values of hole 12′. If the deviation between the actual geometry and the target geometry has only a slight influence, alternatively a determination of funnel angle α can be provided without further steps of orientation of the actual geometry of hole 12′. As soon as the actual position of the funnel-shaped area of hole 12′ is known, the funnel angle or angles α between the relevant planes can be measured, or can be determined from the existing geometry data.

If significant run-in areas are present, the points of intersection between funnel-shaped areas TG′ and surface 14a′ are determined using suitable sectional routines—for example, the formal closing of the gaps in surface 14a′ on the basis of a partial determination of surface 14a′ in funnel-shaped area TG′ of hole 12′, with subsequent calculation of the point of intersection between the funnel edge and a radius of curvature determined therefrom, or on the basis of partially determined surface 14a′ having a defined radius of curvature, or on the basis of the target radius of curvature at the point of intersection, or on the basis of the previously determined surface 14a′ before the perforation. With regard to this aspect of the method as well, the concrete sequence of the individual steps fundamentally depends on the measurement technology that is being used. For further illustration, FIG. 11 shows a schematic top view, as well as a schematic lateral sectional view, of hole 12′ of a further component 10′. The various calculating routines can be used in adapted form in the previously described determination of actual puncture points 18′. If no significant run-in areas are present, the points of intersection between funnel edges TG′ and the respective actual surface 14a′ or 14b′ can be determined immediately from the determined actual geometry of hole 12′. The measurement results can then be represented or evaluated via a corresponding screen display, a protocol, a color representation, or an arbitrary combination of these.

1. A method for measuring at least one hole in at least one first surface of a component, in particular for turbomachines, comprising:
a) provision of a target geometry of the component at least for the area of the hole using a data processing system, the target geometry characterizing at least one first target surface of the component in the area of the hole;
b) determination of an actual geometry of the component at least for the area of the hole using a measurement system, the actual geometry characterizing at least one first actual surface of the component in the area of the hole, and
c) determination of an actual geometry of the hole on the basis of a deviation between the target geometry and the actual geometry of the component, using the data processing system.

2. The method as recited in claim 1, characterized in that the hole extends from the first surface to a second surface of the component.

3. The method as recited in claim 2, characterized in that the target geometry of the component characterizes at least the second target surface, and/or the actual geometry of the component characterizes at least the second actual surface of the component in the area of the hole.

4. The method as recited in claim 1, characterized in that the component and the measurement system are situated relative to one another, in a manner dependent on the construction of the measurement system, before the determination of the actual geometry in step b).

5. The method as recited in claim 1, characterized in that the actual geometry of the component in step b) is determined by means of a tactile and/or optical and/or radiographic and/or ultrasonic measurement device of the measurement system.

6. The method as recited in claim 1, characterized in that the target geometry of the component and/or the actual geometry of the component characterizes a macrogeometry, in particular a dimension and/or a shape, of the hole and/or a microgeometry, in particular a roughness and/or a crack formation, of the hole.

7. The method as recited in claim 1, characterized in that the determination of the actual geometry of the component in step b) is carried out in a predetermined search area of the component.

8. The method as recited in claim 1, characterized in that the actual geometry of the component in step b) is determined on the basis of box dimensions and a shape of at least one surface of the hole, and/or on the basis of length dimensions and angular dimensions.

9. The method as recited in claim 1, characterized in that in step b) component bases, in particular main planes of the component, and/or a target axis of the hole are determined.

10. The method as recited in claim 9, characterized in that the component bases are determined on the basis of base points of the component and/or on the basis of points of support of the component on a measurement device and/or on the basis of a surface acquisition of the component and/or on the basis of a component acquisition.

11. The method as recited in claim 9, characterized in that in step b), on the basis of the target axis of the hole and the actual geometry of the component, a target puncture point of the hole in the actual surface is determined.

12. The method as recited in claim 1, characterized in that in step c) an actual axis of the hole and/or an actual puncture point of the hole in the actual surface is determined.

13. The method as recited in claim 9, characterized in that the target hole axis is used for the determination of the actual hole axis, and/or the actual hole axis is determined on the basis of the target geometry of the component.

14. The method as recited in claim 1, characterized in that an area of the actual geometry of the component that lies outside a predetermined range of tolerance, taking into account the target geometry of the component, is not taken into account in the determination of the actual geometry of the hole in step c).

15. The method as recited in claim 1, characterized in that in step c) a funnel parameter of the hole, in particular a funnel angle and/or a funnel width and/or a funnel depth and/or a funnel edge and/or a funnel transition surface to the surface of the component and/or a radius of curvature between the funnel transition surface and the surface of the component, is determined.

16. The method as recited in claim 1, characterized in that the actual geometry, determined in step c), of the hole is evaluated and/or represented in a further step d).

17. The method as recited in claim 16, characterized in that in step d) a documentation is carried out and/or a representation, in particular a color representation, is produced characterizing a deviation of the actual geometry from the target geometry of the hole.

18. The method as recited in claim 16, characterized in that this method is aborted in the case in which an actual geometry of the hole is evaluated as defective.

19. The method as recited in claim 16, characterized in that the actual geometry of the hole determined in step c) is spatially oriented in a manner dependent on the target geometry of the hole before the evaluation in step d).

20. The method as recited in claim 1, characterized in that a plurality of holes of the component are measured.

21. The method as recited in claim 1, characterized in that the component is a turbine blade of a turbomachine, in particular a thermal turbomachine, and/or the hole is a cooling air hole.

22. A device for measuring at least one hole in at least one first surface of a component, in particular for turbomachines, comprising:
a) a measurement system by means of which an actual geometry of the component can be determined at least for the area of the hole, the actual geometry characterizing at least one first actual surface of the component in the area of the hole; and
b) a data processing system that is capable of being coupled to the measurement system, by means of which a target geometry of the component can be provided at least for the area of the hole, the target geometry characterizing at least one first target surface of the component in the area of the hole, and by means of which an actual geometry of the hole can be determined taking into account the target geometry and the actual geometry of the component.
